(19) United States
(12) Patent Application Publication
(10) Pub. No.: US 2021/0333724 A1
(43) Pub. Date: Oct. 28, 2021

(54) ELECTROPHOTOGRAPHIC BELT AND ELECTROPHOTOGRAPHIC IMAGE FORMING APPARATUS

(71) Applicant: CANON KABUSHIKI KAISHA, Tokyo (JP)

(72) Inventor: Hiroomi Kojima, Kanagawa (JP)

(21) Appl. No.: 17/234,316

(22) Filed: Apr. 19, 2021

(30) Foreign Application Priority Data
Apr. 23, 2020 (JP) 2020-076692
Feb. 12, 2021 (JP) 2021-020725

(51) Int. Cl. G03G 5/07; G03G 15/11; C08L 77/12; G03G 5/05

(52) U.S. Cl. CPC G03G 5/075; G03G 15/11; G03G 2215/0658; G03G 5/0514; G03G 2215/00679; C08L 77/12

(57) ABSTRACT

An electrophotographic belt in which bleeding of a cation component to the outer surface is suppressed after long-term storage after long-term repeated image output. The electrophotographic belt has a layer that includes a thermoplastic resin composition including a thermally melt-kneaded product of a thermoplastic polyester resin, a cation having a hydroxyl group, an anion, and a compound having at least two amide groups in one molecule.

### BACKGROUND

### Field

The present disclosure relates to an electrophotographic belt and an electrophotographic image forming apparatus including the electrophotographic belt.

### Description of the Related Art

Japanese Patent Application Laid-Open No. 2015-230456 has disclosed an electro-conductive belt that is highly electro-conductive and has small fluctuations in electrical resistance even after long-term use. The electro-conductive belt includes a hydrophobic fluorinated sulfoneimide structure in a thermoplastic resin such as polyester or an ionic liquid having hexafluorophosphate as an anion.

### SUMMARY

At least one of aspects of the present disclosure is directed to providing an electrophotographic belt in which the cation component hardly exudes to the surface even after long-term image formation and then long-term leaving, contributing to the stable formation of a high-quality electrophotographic image. In addition, at least one of aspects of the present disclosure is directed to providing an electrophotographic image forming apparatus capable of stably forming a high-quality electrophotographic image. Further, at least one of aspects of the present disclosure is directed to providing a method of producing an electrophotographic belt in which the cation component hardly exudes to the surface even after long-term image formation and then long-term leaving, contributing to the stable formation of a high-quality electrophotographic image.

According to one aspect of the present disclosure, there is provided an electrophotographic belt having a first layer that includes a thermoplastic resin composition containing a thermoplastic polyester resin, a cation having a hydroxyl group, an anion, and a compound having at least two amide groups in one molecule. According to another aspect of the present disclosure, there is provided an electrophotographic image forming apparatus including the above electrophotographic belt as an intermediate transfer belt. According to further aspect of the present disclosure, there is provided a method of producing an electrophotographic belt having an endless shape, and is provided with a first layer comprising a thermoplastic resin composition, the method comprising the steps of: (i) thermally melt-kneading a thermoplastic polyester resin, an ionic compound containing a cation having a hydroxyl group and an anion, and an amide compound having at least two amide groups in one molecular to form the thermoplastic resin composition; and (ii) molding the thermoplastic resin composition into an endless belt shape.

Further features of the present disclosure will become apparent from the following description of exemplary embodiments with reference to the attached drawings.

### BRIEF DESCRIPTION OF THE DRAWINGS

FIG. 1 is a schematic cross-sectional view illustrating an example of a full-color electrophotographic image forming apparatus using an electrophotographic process.

FIG. 2 is a schematic cross-sectional view of an injection molding apparatus used in the embodiment.

FIG. 3 is an explanatory schematic view of a primary blow molding apparatus used in the examples.

FIG. 4 is an explanatory schematic view of a secondary blow molding apparatus used in the examples.

FIG. 5 is an explanatory diagram of a mechanism exerting an effect of an electrophotographic belt according to the present disclosure.

FIGS. 6A, 6B and 6C are explanatory diagrams of configuration examples of the electrophotographic belt according to the present disclosure.

### DESCRIPTION OF THE EMBODIMENTS

According to the investigation, the electrophotographic belt according to Japanese Patent Application Laid-Open No. 2015-230456 was used for forming an electrophotographic image for a long period of time as an intermediate transfer belt, and then left for a predetermined period of time, and thereafter when used for forming an electrophotographic image again, an image failure due to poor transfer of the toner was observed.

The present inventors investigated the image failures that occurred when the above electrophotographic belt according to Japanese Patent Application Laid-Open No. 2015-230456 was used as an intermediate transfer belt for forming an electrophotographic image. Specifically, observed was a portion corresponding to the position of the image failure on the toner-supporting surface of the electrophotographic belt. As a result, untransferred toner and sticky deposit were confirmed. Further elemental analysis of this deposit confirmed that this deposit was a cation component of the ionic liquid contained in the electrophotographic belt. From this, in order to form a high-quality electrophotographic image more stably, the present inventors have recognized that it is necessary to develop technology to further suppress the exuding (bleeding) cation component in the electrophotographic belt that is conductive with the ionic liquid.

Herein, the reason why the cation component bleeds on the belt surface after the electrophotographic belt according to Japanese Patent Application Laid-Open No. 2015-230456 is repeatedly used to output an image for a longer period than before and stored for a long period of time is presumed as follows.

That is, the polyester resin contained in the thermoplastic resin composition and the cation and the anion are not completely compatible with each other, and microscopically, the polyester resin phase and the cation-and-anion phase are mixed. Therefore, one of the cation and anion moves toward one surface of the belt and the other moves toward the other surface (back surface) of the belt depending on the direction of voltage application.

The process of forming an electrophotographic image has a primary transfer in which the toner on the photosensitive drum is transferred to an electrophotographic belt and a secondary transfer in which the toner on an electrophotographic belt is transferred to a transfer medium. The directions of voltage application to the electrophotographic belt for the primary transfer and secondary transfer are opposite to each other in the thickness direction of the electrophotographic belt.

The amounts of energization due to the voltage applied in opposite directions in the primary transfer and the secondary transfer are typically different, and therefore the cation and the anion in the thickness direction tend to be unevenly distributed in one direction. Therefore, the image is repeatedly output for a longer period of time than before, and thereby the cation and anion are unevenly distributed closer to the belt surface.

When the electrophotographic belt is stored for a long period of time in such a condition, a force for moving the cation component toward the outer surface of the electrophotographic belt is exerted in an attempt to reduce the difference in interfacial energy between the outer surface of the electrophotographic belt and the atmosphere, and the cation component bleeds onto the outer surface of the electrophotographic belt.

The present inventors have performed repeated investigations to suppress the bleeding of such cations. As a result, the present inventors have found that the bleeding of the cation component to the outer surface can be better suppressed by the electrophotographic belt having a layer that includes the thermoplastic resin composition including a thermally melt-kneaded product of a thermoplastic polyester resin (hereinafter, also simply referred to as “polyester resin”), a cation having a hydroxyl group, an anion, and a compound having at least two amide groups in one molecule.

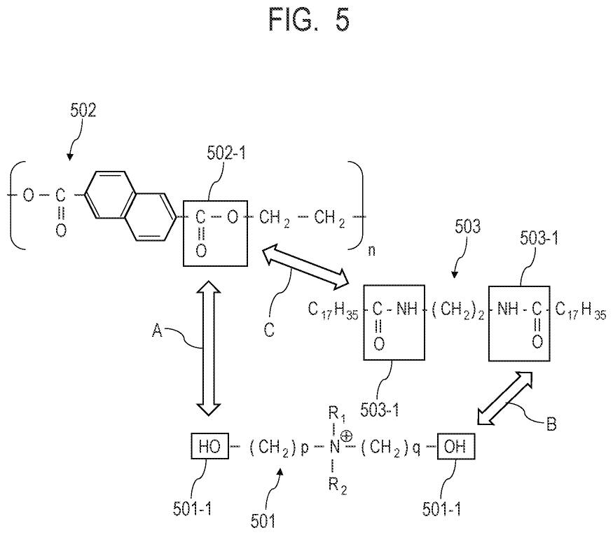

FIG. 5 describes the assumed mechanism by which the exuding of the cation component can be better suppressed by the electrophotographic belt having the above configuration. Cation 501 having hydroxyl groups, polyethylene naphthalate 502 as a polyester resin, and ethylene bisstearic acid amide 503 as a compound having at least two amide groups in one molecule as illustrated in FIG. 5 are merely examples, and the present disclosure is not limited to these compounds.

Cation 501 having hydroxyl groups and polyester resin 502 interact with each other by a hydrogen bond or a transesterification reaction between hydroxyl group 501-1 and ester bond 502-1 of polyester resin 502 (referred to arrow A in FIG. 5), and therefore has a high affinity. In addition, cation 501 having hydroxyl groups and compound 503 having at least two amide groups in one molecule (hereinafter, sometimes simply referred to as “amide compound”) interact with each other between hydroxyl group 501-1 and amide group 503-1 (referred to arrow B in FIG. 5), and therefore exhibit a high affinity. Moreover, amide compound 503 and polyester resin 502 interact with each other between amide group 503-1 and ester bond 502-1 of the polyester resin (referred to arrow C in FIG. 5), and therefore exhibit a high affinity. As described above, it is considered that amide compound 503 having two or more amide groups in one molecule promotes further improvement of the affinity between cation component 501 having hydroxyl groups and polyester resin 502. Arrows A, B, and C in FIG. 5 schematically show one aspect of the interaction between the hydroxyl group, the ester bond, and the amide group, and in actual, these functional groups and bond are considered to complicatedly interact with each other. In addition, in FIG. 5, n, p, and q each independently represent an integer of 1 or more, and R₁ and R₂ each independently represent a hydrogen atom or an organic group.

In addition, as illustrated in FIG. 5, when the above cation has two or more hydroxyl groups, the interaction between the polyester resin and the amide compound is further enhanced, and thereby the bleeding of the cation to the outer surface of the electrophotographic belt can be further suppressed.

Moreover, even when the first layer contains a polyether ester amide (PEEA) as one of optional ingredients, PEEA includes an ester bond and an amide group in the molecule, and therefore the mechanism as described above can suppress the bleeding of PEEA to the outer surface of the electrophotographic belt. In this connection, PEEA functions as a polymeric ion conductive agent, and therefore is a preferable ingredient for further increasing the electro-conductivity of the first layer of the electrophotographic belt.

The electrophotographic belt according to one aspect of the present disclosure has a layer that includes a thermoplastic resin composition containing a thermally melt-kneaded product of a thermoplastic polyester resin, a cation having a hydroxyl group, anion, and a compound having at least two amide groups in one molecule. In the present description, a compound having a cation and a paired anion may be referred to as an “ionic compound”.

<Thermoplastic Resin Composition>

The thermoplastic resin composition according to the present disclosure includes a thermally melt-kneaded product of a thermoplastic polyester resin, a cation having a hydroxyl group, anion, and a compound having at least two amide groups in one molecule. For example, the thermally melt-kneaded product can be obtained by thermally melt kneading a component including a thermoplastic polyester resin, a cation having a hydroxyl group, anion, and a compound having at least two amide groups in one molecule. The afore-mentioned PEEA can also be thermally melt kneaded with these components.

The thermally melt kneading means that the resin contained in the thermoplastic resin composition is heated and kneaded in a molten condition. In the thermally melt kneading, the resin having the highest melting point among the resins contained in the thermoplastic resin composition can be kneaded at a temperature or more of the highest melting point so as to be well kneaded. The kneading method is not particularly limited, and a single-screw extruder, a twin-screw kneading extruder, a Banbury mixer, a roll, a Brabender, a plastograph, or a kneader can be used.

<Thermoplastic Polyester Resin>

The thermoplastic polyester resin can be obtained by polycondensation of a dicarboxylic acid and a diol, polycondensation of an oxycarboxylic acid or a lactone, or polycondensation with a plurality of these components. Further polyfunctional monomers may be used in combination. The thermoplastic polyester resin may be a homopolyester including one ester bond or may be a copolyester (copolymer) including a plurality of ester bonds.

Preferable examples of the thermoplastic polyester resin include at least one selected from the group consisting of polyalkylene terephthalate and polyalkylene naphthalate having high crystallinity and exhibiting excellent heat resistance. In addition, a copolymer of polyalkylene terephthalate or polyalkylene naphthalate and polyalkylene isophthalate can be preferably used as the copolyester (copolymer).

The form of the above copolymer may be a block copolymer or a random copolymer.

The carbon number of the alkylene in the polyalkylene terephthalate, the polyalkylene naphthalate, and the polyalkylene isophthalate is preferably 2 or more and 16 or less from the viewpoint of high crystallinity and heat resistance. More specifically, polyethylene terephthalate, polyethylene naphthalate, and a copolymer of polyethylene terephthalate and polyethylene isophthalate are preferable as the thermoplastic polyester resin.

The intrinsic viscosity of the thermoplastic polyester resin is preferably 1.4 dl/g or less, more preferably 0.3 dl/g or more and 1.2 dl/g or less. Thermoplastic polyester resin with intrinsic viscosity of 1.4 dl/g or less has excellent fluidity during the thermally melt kneading step. When the intrinsic viscosity is 0.3 dl/g or more, the strength and durability of the electrophotographic belt can be improved more easily. The intrinsic viscosity of the thermoplastic polyester resin is a value measured in the condition that o-chlorophenol is used as a diluting solvent for the thermoplastic polyester resin, the concentration of the o-chlorophenol solution of the thermoplastic polyester resin is 0.5% by mass, and the temperature is 25° C.

In addition, the content of the thermoplastic polyester resin in the thermoplastic resin composition is preferably 50% by mass or more, more preferably 60% by mass or more, and still more preferably 70% by mass or more, with respect to the total mass of the thermoplastic resin composition. The content of the thermoplastic polyester resin is set to 50% by mass or more with respect to the total mass of the thermoplastic resin composition, easily increasing the mechanical strength of the thermoplastic resin composition.

<Cation Having Hydroxyl Group>

The cation having hydroxyl groups is not particularly limited, and examples thereof include ammonium-based ions, imidazolium-based ions, pyridinium-based ions, piperidinium-based ions, pyrrolidinium-based ions, and phosphonium-based ions. Of these, ammonium-based ions and imidazolium-based ions are preferable from the viewpoint such as cost.

Specific examples of the above cation include 2-hydroxyethylammonium ion, 2-hydroxypropylammonium ion, 2-hydroxyethyl-trimethylammonium ion, 2-hydroxypropyl-trimethylammonium ion, 2-hydroxy-3-methacryloyloxypropyltrimethylammonium ion, and N-oleyl-N,N-di(2-hydroxyethyl)-N-methylammonium ion. The above cations may be used singly or may be used in combination of two or more.

The content of cations contained in the electrophotographic belt together with the content of paired anions (the content of ionic compounds) is preferably 0.5% by mass or more with respect to the total amount of the thermoplastic resin composition, from the viewpoint of the electric resistance of the electrophotographic belt. The upper limit is not particularly limited; however, adding the content of more than 8% by mass limits the effect of reducing the electric resistance. In addition, from the viewpoint of good moldability of the thermoplastic resin composition, the content of 8% by mass or less is preferable. In addition, the blending to the thermoplastic resin composition can be performed as an ionic compound.

<Anion>

The anion is not particularly limited as long as it can form an ionic compound by pairing with the above cation, and examples thereof includes ClO₄⁻, Br⁻, Cl⁻, AlCl₄⁻, Al₂Cl₇⁻, NO₃⁻, BF₄⁻, PF₆⁻, CH₃COO⁻, CF₃COO⁻, CF₃SO₃⁻, (CF₃SO₂)₃C⁻, AsF₆⁻, SbF₆⁻, F(HF)ₙ⁻, CH₃CH₂OSO₃⁻, H₂PO₄⁻, CF₃CF₂CF₂CF₂SO₃⁻, CF₃CF₂CF₂COO⁻, and the anion represented by following Formula (1). Of these, the sulfoneimide-based anion represented by the following structural formula (1) is preferable from the viewpoints such as affinity with polyester resin and electro-conductivity.

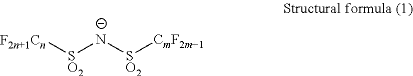

In structural formula (1), m and n each independently represent an integer of 1 or more and 4 or less.

Specific examples of the anion satisfying the structural formula (1) include bis(trifluoromethanesulfonyl)imide ion, bis(perfluoroethanesulfonyl)imide ion, bis(perfluoropropanesulfonyl)imide ion, bis(nonafluorobutanesulfonyl)imide ion (bis(perfluorobutanesulfonyl)imide ion), trifluoromethanesulfonylperfluoropropanesulfonylimide ion, and trifluoromethanesulfonylperfluorobutanesulfonylimide ion. The above anions may be used singly or may be used in combination of two or more.

<Compound Having at Least Two Amide Groups in One Molecule (Amide Compound)>

The compound having at least two amide groups in one molecule preferably has a molecular weight of 1000 or less, particularly 800 or less. In addition, the lower limit of the molecular weight of the amide compound is not particularly limited; however, is preferably 200 or more. It is considered that the molecular weight of the amide compound within the above range can provide more efficient interaction among the thermoplastic polyester, the ionic liquid, and the amide compound during the thermally melt kneading step.

In addition, the amide compound is preferably melted at the temperature in the thermally melt kneading step. The melting point thereof is preferably 70° C. or more and less than 200° C., and more preferably 100° C. or more and 170° C. or less. When the melting point is within the above range, the amide compound is excellent in dispersibility or distributivity in the thermoplastic resin composition, is easily arranged between the polyester resin and the molecules of cations and anions, and is hardly decomposed by thermal deterioration, during the thermally melt kneading step. Therefore, it is easy to further enhance the effect of suppressing the bleeding.

Fatty acid bisamide is preferable as the compound having at least two amide groups. The fatty acid bisamide includes a fatty acid group (preferably a long-chain fatty acid group) and an amide group in the molecule, has excellent compatibility with a thermoplastic polyester resin, and is relatively stable thermally and chemically.

From the viewpoint of compatibility with the thermoplastic polyester resin and thermal and chemical stability, the carbon number range of the long-chain fatty acid group is preferably 7 to 23. Aromatic bisamide may be used as the compound having at least two amide groups. Aromatic bisamide is one that includes fatty acid groups and amide groups in the molecule, in which the amide groups are bonded with an aromatic hydrocarbon.

Alkylene bis fatty acid amides such as ethylene bis(fatty acid amide) can be used as the fatty acid bis amide. Specific examples thereof include methylene bisstearic acid amide (Tm (melting point): 142° C.), ethylene biscapric acid amide (Tm: 161° C.), ethylene bislaurate amide (Tm: 157° C.), ethylene bisstearic acid amide (Tm: 145° C.), ethylene bishydroxystearic acid amide (Tm: 145° C.), ethylene bisbehenic acid amide (Tm: 142° C.), hexamethylene bisstearic acid amide (Tm: 140° C.), hexamethylenebisbehenic acid amide (Tm: 142° C.), hexamethylenebishydroxystearic acid amide (Tm: 135° C.), N, N′-distearyl adipic acid amide (Tm: 141° C.), N, N′-distearyl sebacic acid amide (Tm: 136° C.), ethylene bisoleate amide (Tm: 115° C.), ethylene biserucic acid amide (Tm: 120° C.), hexamethylenebisoleic acid amide (Tm: 110° C.), N,N′-diorail adipic acid amide (Tm: 118° C.), and N,N′-diorail sebacic acid amide (Tm: 113° C.).

The content (mass) of the compound having at least two amide groups in one molecule is preferably 2% or more and 80% or less with respect to the total content of the cations and anions (mass of the ionic compound). It is more preferably 5% or more and 50% or less.

When the content is 2% or more, the number of amide groups that interact with the thermoplastic polyester resin and the cations and anions is large, which is preferable in order to further suppress the bleeding. In addition, when it is 80% or less, it is easy to suppress a decrease in the melt viscosity of the thermoplastic resin composition and thus suppress a decrease in the strength of the electrophotographic belt. In addition, it is easy to suppress an excessive decrease in the mobility of the cations and the anions and thus suppress an increase in electric resistance of the electrophotographic belt.

<Polyether Ester Amide (PEEA)>

Examples of PEEA include the compound mainly having a copolymer that consists of polyamide block units, such as nylon 6, nylon 66, nylon 11, and nylon 12, and polyether ester units.

Examples thereof include the copolymer derived from a salt of lactam (for example, caprolactam, lauryl lactam) or aminocarboxylic acid, polyethylene glycol, and dicarboxylic acid. Specific examples of the above dicarboxylic acid include terephthalic acid, isophthalic acid, adipic acid, azelaic acid, sebacic acid, undecanedioic acid, and dodecanedioic acid. PEEA can be produced by a known polymerization method such as melt polymerization. Of course, PEEA is not limited to these. In addition, PEEA may be a blend or an alloy of two or more. The compound having at least two amide groups in one molecule used in the present disclosure is mainly a low molecular weight compound having a molecular weight of 1000 or less, while PEEA is a high molecular weight compound having a molecular weight larger than that of the above compound.

<Other Additive(s)>

Other components may be added to the thermoplastic resin composition as long as the effects of the present disclosure are not impaired. Examples of other components include electro-conductive polymer compounds, antioxidants, UV absorbers, organic pigments, inorganic pigments, pH regulators, cross-linking agents, compatibilizers, mold release agents, cross-linking agents, coupling agents, lubricants, insulating fillers, and electro-conductive fillers. These additives may be used singly or may be used in combination of two or more. The amount of the additive used can be appropriately set and is not particularly limited.

<Electrophotographic Belt>

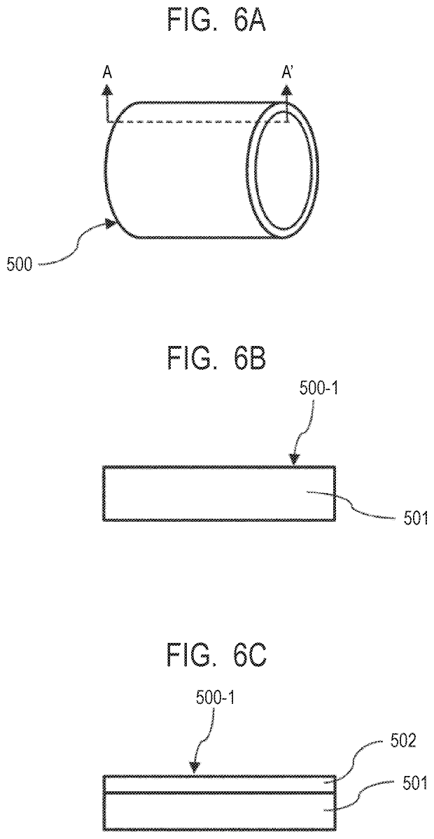

FIG. 6A illustrates a perspective view of electrophotographic belt 500 having an endless belt shape according to one aspect of the present disclosure. Examples of the layer configuration include a monolayer structure in which the cross section of the line A-A′ in FIG. 6B is composed of only the first layer 501 including the thermoplastic resin composition as illustrated in FIG. 6B. In this case, the outer surface 500-1 of the first layer is the toner-supporting surface (outer surface) of the electrophotographic belt.

In addition, another example of the layer configuration includes a laminated structure in which the cross section of the A-A′ line has the first layer 501 and the second layer 502 covering the outer peripheral surface of the first layer 501 as illustrated in FIG. 6C. When the second layer 502 is provided, the outer surface 500-1 of the second layer 502 serves as the toner-supporting surface of the electrophotographic belt.

Examples of the second layer include a layer having excellent wear resistance, the layer including a cured product of an active energy ray-curable resin. Such a second layer can be provided, for example, by applying onto the outer peripheral surface of the first layer a composition containing an active energy ray-curable resin such as a photocurable resin and then curing the composition.

The effect of the present disclosure in the electrophotographic belt having such a laminated structure is that reduction of adhesion between the first layer and the second layer is suppressed by suppression of exuding of the cation component at the interface between the first layer and the second layer.

In addition, the third layer (not illustrated) may be provided to cover the inner peripheral surface of the first layer. Examples of the third layer include a resin layer for reinforcing the first layer and an electro-conductive layer for making the inner peripheral surface of the electrophotographic belt electro-conductive.

The first layer having an endless belt shape can be produced, for example, by the following method.

i) A method of melt-extruding into a cylindrical shape a mixture of a thermoplastic polyester resin, an ionic electro-conductive agent having a sulfoneimide structure as an anion, and a compound having at least two amide groups in one molecule.

ii) A method of molding pellets of the thermoplastic resin composition into an endless belt shape by using a molding method such as injection molding, stretch blow molding, or inflation molding.

Examples of the method of i) described above include a downward extrusion type internal cooling mandrel method capable of controlling the inner diameter of an extruded tube with high accuracy, and a vacuum sizing method.

The method for producing an electrophotographic belt by stretch blow molding in ii) described above includes the following steps: molding a preform of the thermoplastic resin composition; heating the preform; mounting the heated preform on a mold for endless belt molding and then inflowing gas into the mold to perform stretch blow molding; and cutting a stretched molded product obtained by the stretch blow molding to obtain an endless shaped belt.

The thickness of the first layer is preferably 40 μm or more and 500 μm or less, and particularly preferably 50 μm or more and 100 μm or less.

In order to improve the appearance of the surface of the electrophotographic belt and improve the releasability of toner for example, a treatment agent may be applied onto the surface of the thermoplastic resin composition layer, or a surface treatment such as polishing treatment may be performed. In addition, the outermost layer may be provided on the surface of the thermoplastic resin composition layer by sputtering for example.

The use of the electrophotographic belt is not particularly limited, and is preferably used for, for example, an intermediate transfer belt that temporarily transfers and holds a toner image, and a conveyance transfer belt that conveys a recording material as a transfer material. Particularly, it can be preferably used as an intermediate transfer belt. In addition, when the electrophotographic belt is used as the intermediate transfer belt, the surface specific resistivity of the electrophotographic belt is preferably 1×10³ Ω/□ or more and 1×10¹²Ω/□ or less. When the surface specific resistivity is 1×10³Ω/□ or more, reduction of the resistance can be prevented, a transfer electric field can be easily obtained, and image omission and roughness can be effectively prevented. When the surface specific resistivity is 1×10¹²Ω/□ or less, the increase in the transfer voltage can be more effectively suppressed, and the increases in size and cost of the power supply can be effectively suppressed.

<Electrophotographic Image Forming Apparatus>

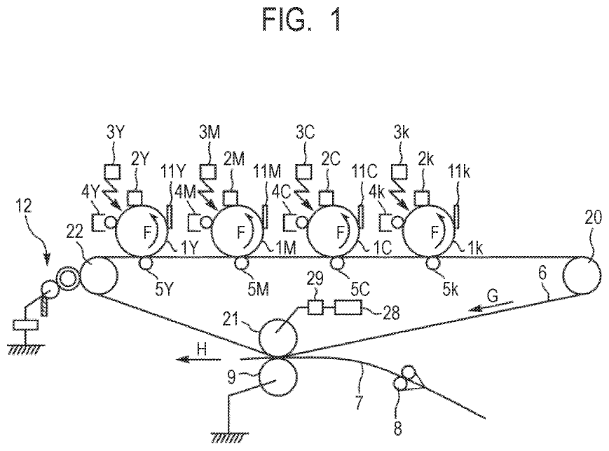

Hereinafter, an example of an electrophotographic image forming apparatus including the electrophotographic belt according to one aspect of the present disclosure as an intermediate transfer belt will be described below. As illustrated in FIG. 1, this electrophotographic image forming apparatus has a so-called tandem type configuration in which electrophotographic stations of a plurality of colors are arranged side by side in the rotation direction of the intermediate transfer belt. In the following explanation, the codes of the configurations for each color of yellow, magenta, cyan, and black are subscripted with Y, M, C, and k, respectively; however, the subscripts may be omitted for the same configuration.

In FIG. 1, charging devices 2Y, 2M, 2C, and 2k, exposing devices 3Y, 3M, 3C, and 3k, developing devices 4Y, 4M, 4C, and 4k, and intermediate transfer belt (intermediate transfer body) 6 are arranged around photosensitive drums (photosensitive member, image carrier) 1Y, 1M, 1C, and 1k. Photosensitive drum 1 is rotationally driven at a predetermined peripheral speed (process speed) in the direction of arrow F. Charging device 2 charges the peripheral surface of photosensitive drum 1 to a predetermined polarity and potential (primary charging). The laser beam scanner as exposing device 3 outputs laser light that has been on/off-modulated in response to image information input from an external device such as an image scanner or a computer (not illustrated), and thereby the charged surface on photosensitive drum 1 is scanned and exposed. This scanning exposure forms an electrostatic latent image corresponding to the target image information on the surface of photosensitive drum 1.

Developing devices 4Y, 4M, 4C, and 4k contain toners of color components of yellow (Y), magenta (M), cyan (C), and black (k), respectively. Developing device 4 to be used is selected based on the image information, the developing agent (toner) is developed on the surface of photosensitive drum 1, and the electrostatic latent image is visualized as a toner image. The present embodiment uses a reverse development method in which toner is adhered to the exposed portion of the electrostatic latent image to develop the image. In addition, such a charging device, an exposing device, and a developing device constitute an electrophotographic image forming unit.

In addition, intermediate transfer belt 6 is composed of an electrophotographic belt having an endless shape. Intermediate transfer belt 6 is stretched by a plurality of rollers 20, 21, and 22 so that the outer peripheral surface thereof comes into contact with the surface of photosensitive drum 1. In the present embodiment, roller 20 is a tension roller for controlling the tension of intermediate transfer belt 6 to be constant, roller 22 is a drive roller for intermediate transfer belt 6, and roller 21 is an opposing roller for secondary transfer. Intermediate transfer belt 6 is rotated in the direction of arrow G by the drive of roller 22. In addition, each of primary transfer rollers 5Y, 5M, 5C, and 5k is arranged at the primary transfer positions facing photosensitive drum 1 with the intermediate transfer belt 6 interposed therebetween.

The unfixed toner images of each color formed on photosensitive drum 1 are sequentially and electrostatically primary-transferred onto intermediate transfer belt 6 by applying a primary transfer bias having a polarity opposite to the charging polarity of the toner to primary transfer roller 5 with a constant voltage source or constant current source (not illustrated). Then, obtained is a full-color image in which four colors of unfixed toner images are superposed on intermediate transfer belt 6. Intermediate transfer belt 6 rotates while carrying the toner image transferred from photosensitive drum 1 in this way. At each rotation of photosensitive drum 1 that has been primary-transferred, the surface of photosensitive drum 1 is cleaned with the transfer residual toner removed by cleaning device 11, and the image-forming step is repeated.

In addition, at the secondary transfer position of intermediate transfer belt 6 facing the conveyance path of recording material 7 as the transfer medium, secondary transfer roller (transfer portion) 9 is pressure-welded on the toner image supporting surface side of intermediate transfer belt 6. In addition, on the back surface side of intermediate transfer belt 6 at the secondary transfer position, arranged is counter roller 21 that serves as the counter electrode of secondary transfer roller 9 and the bias is applied thereto. When the toner image on intermediate transfer belt 6 is transferred to recording material 7, a bias having the same polarity as the toner, for example, −1000 to −3000V is applied to counter roller 21 by transfer bias applying apparatus 28, and then a current of −10 to 50 μA flows. This transfer voltage is detected by transfer voltage detecting apparatus 29. Moreover, on the downstream side of the secondary transfer position, provided is a cleaning device (belt cleaner) 12 for removing the toner remaining on intermediate transfer belt 6 after the secondary transfer.

Recording material 7 passes through conveyance guide 8 and is conveyed in the direction of arrow H, and is introduced at the secondary transfer position. Recording material 7 introduced at the secondary transfer position is held and conveyed to the secondary transfer position, and a constant voltage bias (transfer bias) being controlled to a predetermined value is applied to counter roller 21 of the secondary transfer roller 9 by secondary transfer bias applying apparatus 28. Applying a transfer bias having the same polarity as the toner to counter roller 21 collectively transfers onto recording material 7 a four-color full-color image (toner image) superposed on intermediate transfer belt 6 at the transfer site, and thus a full-color unfixed toner image is formed on the recording material. Recording material 7 to which the toner image has been transferred is introduced into a fuser (not illustrated) and heat-fixed.

One aspect of the present disclosure can provide an electrophotographic belt in which the surface condition of the belt hardly changes from the initial condition during long-term storage after long-term repeated image output. In addition, another aspect of the present disclosure can provide an electrophotographic image forming apparatus capable of stably forming a high-quality electrophotographic image.

### EXAMPLE

Examples and comparative examples will be shown below, and the electrophotographic belt and the electrophotographic image forming apparatus according to the present disclosure will be specifically described. The electrophotographic belt and the electrophotographic image forming apparatus according to the present disclosure are not limited to the configurations embodied in the examples.

The materials described in Table 1 to Table 5 below were prepared as the materials used for producing the electrophotographic belt according to examples and comparative examples (thermoplastic polyester resin, ionic compounds having cations and anions, amide compounds, polyether ester amides, and silicone particles).

The cation in the ionic compounds 1 to 6 shown in Table 2 correspond to the cation having hydroxyl groups, while the cation in ionic compound 7 do not correspond to this cation having hydroxyl groups. In addition, the amide compounds 1 and 2 shown in Table 3 correspond to compounds having at least two amide groups in one molecule, while amide compound 3 does not correspond to this compound.

TABLE 1
<Thermoplastic polyester resin>

| Polyester resin | |
|---|---|
| No. | Name (product name) |
| 1 | Polyethylene terephthalate |
| | (Product name: TRN-8550FF, |
| | manufactured by Teijin Limited) |
| 2 | Polyethylene naphthalate |
| | (Product name: TN-8050SC, |
| | manufactured by Teijin Limited) |
| 3 | Copolymer of polyethylene terephthalate |
| | and polyethylene isophthalate |
| | (Product name: PIFG30, manufactured by |
| | Bell Polyester Products, Inc.) |

TABLE 2
<Ionic compound having cation and anion>

| Ionic compound | |
|---|---|
| No. | Name (product name) |
| 1 | 2-Hydroxyethyl-trimethylammonium acetate |
| | (Also known as: choline acetate, manufactured |
| | by FUJIFILM Wako Pure Chemical Corporation) |
| 2 | 2-Hydroxyethyl-trimethylammonium-bis |
| | (trifluoromethanesulfonyl) imide (Also known |
| | as: Choline bis(trifluoromethylsulphonyl)imide, |
| | manufactured by Kanto Chemical Co., Inc.) |
| 3 | 2-Hydroxy-3- |
| | methacryloyloxypropyltrimethylammonium- |
| | bis(trifluoromethanesulfonyl)imide |
| | (FUJIFILM Wako Pure Chemical Corporation) |
| 4 | N-oleyl-N,N-di(2-hydroxyethyl)-N- |
| | Methylammonium = |
| | bis(trifluoromethanesulfonyl)imide |
| | (FUJIFILM Wako Pure Chemical Corporation) |
| 5 | 2-(2-Hydroxyethyl)-3-methylimidazolium |
| | tetrafluoroborate (Kanto Chemical Co., Inc.) |
| 6 | 1-(2-Hydroxyethyl)-3-methylimidazolium |
| | bis(trifluoromethanesulfonyl)imide |
| | (Kanto Chemical Co., Inc.) |
| 7 | N,N,N-trioctyl-N-methylammonium- |
| | bis(trifluoromethanesulfonyl)imide |
| | (Product name: MTOA-TFSI, manufactured by |
| | Toyo Gosei Co., Ltd.) |

TABLE 3
<Amide compound>

| Amide compound | |
|---|---|
| No. | Name (product name) |
| 1 | Ethylene bisstearic acid amide |
| | (Product name: Denon PB-1239, manufactured |
| | by Marubishi Oil Chemical Corporation) |
| | Melting point = 145° C. |
| 2 | Ethylene biscapric acid amide |
| | (Product name: Slipax C, manufactured |
| | by Mitsubishi Chemical Corporation) |
| | Melting point = 161° C. |
| 3 | Stearic acid monoamide |
| | (Product name: Alflo S-10, manufactured |
| | by NOF CORPORATION) |
| | Melting point = 103° C. |

The structure of ethylene bisstearic acid amide (molecular weight=593) is shown below.

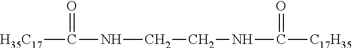

The structure of ethylene biscapric acid amide (molecular weight=369) is shown below.

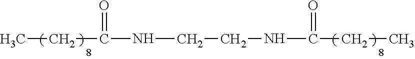

The structure of sterianic acid amide (molecular weight=284) is shown below.

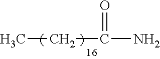

TABLE 4
<Polyether ester amide (PEEA)>

| PEEA | |
|---|---|
| No. | Name (product name) |
| 1 | Polyester ester amide |
| | (Product name: TPAE H, 151, manufactured by |
| | T&K TOKA Co., Ltd.) |
| 2 | Polyester ester amide |
| | (Product name: Perestat NC6321, manufactured |
| | by Sanyo Chemical Industries, Ltd.) |

TABLE 5
<Silicone particles>

| | Name (product name) |
|---|---|
| Silicone | Polymethylsilsesquioxane |
| particles | (Product name: Tospearl 120, manufactured by |
| | Momentive Performance Materials Inc.) |

(Measurement Method and Evaluation Method of Characteristic Value)

The evaluation methods (1) to (4) of the electrophotographic belt according to the examples and the comparative examples will be described below. In the following evaluation, A4 size paper with Ra (arithmetic mean roughness) of 4 and Rzjis (10-point average roughness) of 15, obtained by being left in an environment with a temperature of 23° C. and a relative humidity of 45% for 1 day, was used as the transfer medium used for image formation.

(1) Surface Specific Resistivity

The surface specific resistivity of the electrophotographic belt was measured based on the method specified in Japanese Industrial Standards (JIS)-K6911 1995. A probe having a high resistance meter (trade name: Hiresta UP MCP-HT450 type) with an inner diameter of 50 mm for the main electrode, an inner diameter of 53.2 mm for the guard ring electrode, and an outer diameter of 57.2 mm (trade name: UR-100) was used as a measuring device. The high resistance tester and probe are manufactured by Mitsubishi Chemical Analytech Co., Ltd.

The produced electrophotographic belt was left in an environmental test room controlled at a temperature of 23° C. and a relative humidity of 50% for 12 hours. Thereafter, a voltage of 250V was applied to the electrophotographic belt to be measured for 10 seconds under an environment of a temperature of 23° C. and a relative humidity of 50%, and the surface specific resistivity at four points in the circumferential direction of this electrophotographic belt was measured. The logarithm of the average value (ρs) of the obtained surface specific resistivity based on 10 was defined as log ρs and used as an index of electric resistance. The values shown in the “Surface specific resistivity” column of Tables 6 to 8 are the values of this log ρs.

(2) Initial Toner Transfer Efficiency

The produced electrophotographic belt was attached to the drum cartridge of a full-color electrophotographic apparatus (trade name: LBP-5200, manufactured by Canon Inc.) as an intermediate transfer belt. Using this full-color electrophotographic apparatus, cyan toner and magenta toner were superposed on the transfer medium to form a solid purple image.

The toner transfer efficiency was calculated from the amount of toner F (g) held on the surface of the electrophotographic belt by the primary transfer from the photosensitive drum, and the amount of the residual toner S (g) remaining on the surface of the electrophotographic belt when the toner was secondary transferred to the transfer medium. Specifically, it is represented by the following formula [1].

Toner transfer efficiency (%)=(1−S/F)×100 [1]

(3) Toner Transfer Efficiency after Durability Test

For the image formed on the 300000th transfer medium, the toner transfer efficiency was measured by the same method as in (2).

(4) Toner Transfer Efficiency of Electrophotographic Belt Left for 10 Days after Durability Test

The electrophotographic belt after durability test in (3) was stored for 10 days in a full-color electrophotographic apparatus under the control of a temperature of 23° C. and a relative humidity of 50%, and then cyan toner and magenta toner were superposed on the transfer medium to form a solid purple image. For the image formed on the transfer medium, the toner transfer efficiency was measured by the same method as in (2).

### Examples 1 to 10

The materials were pre-blended according to the formulations shown in Table 6, and then thermally melt kneaded by using a twin-screw extruder (trade name: TEX44α, manufactured by The Japan Steel Works, Ltd.) to prepare a pellet-shaped thermoplastic resin composition. The temperature of the thermally melt kneading step was adjusted to be within the range of 270° C. or more and 300° C. or less, and the time of the thermally melt kneading step was set to about 3 minutes.

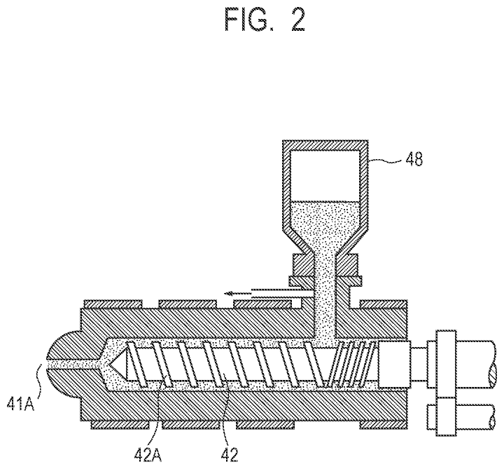

The obtained pellet-shaped thermoplastic resin composition was dried at a temperature of 140° C. for 6 hours. Thereafter, the dried pellet-shaped thermoplastic resin composition was put into hopper 48 of an injection molding apparatus (trade name: SE180D, manufactured by Sumitomo Heavy Industries, Ltd.) having the configuration illustrated in FIG. 2.

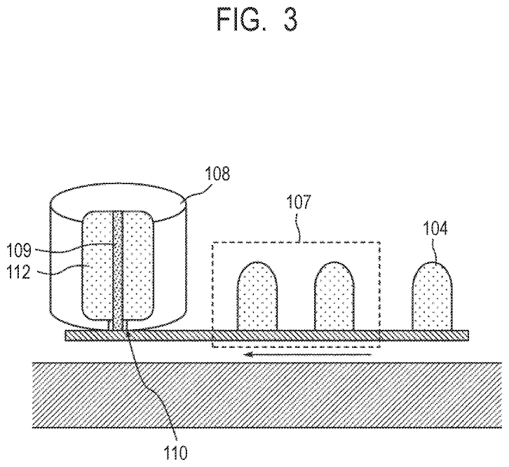

The set temperature of the cylinder was set to 290° C., the above composition was melted in screws 42 and 42A, and injection molded into a mold (not illustrated) through nozzle 41A to prepare preform 104 (refer to FIG. 3). This mold temperature for injection molding was 30° C.

Thereafter, preform 104 was placed in heating device 107 at a temperature of 500° C. in the primary blow molding apparatus illustrated in FIG. 3 to be softened, and preform 104 was heated at 500° C. In blow mold 108 with the mold temperature maintained at room temperature, blow bottle 112 was obtained by blow molding using the forces of stretching rod 109 and air (blow air injection portion 110) at a preform temperature of 160° C., an air pressure of 0.3 MPa, and a stretching rod speed of 1000 mm/s.

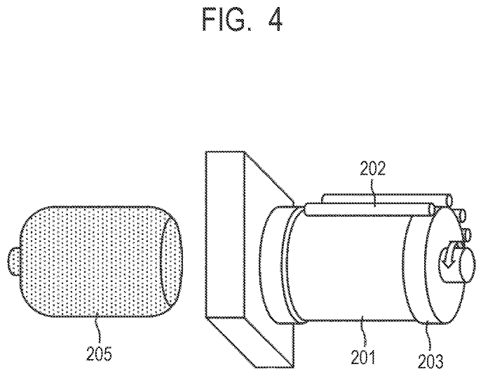

Thereafter, obtained blow bottle 205 was set in nickel cylindrical mold 201 produced by electroforming in the secondary blow molding apparatus illustrated in FIG. 4, and outer mold 203 was mounted. An air pressure of 0.1 MPa was added into blow bottle 205 and air was adjusted not to leak to the outside, and thereby blow bottle 205 was transferred to the inner surface of the mold, and nickel cylindrical mold 201 was heated uniformly by heater 202 at 190° C. for a total of 60 seconds while being rotated.

Thereafter, air was blown onto this nickel cylindrical mold to cool it to room temperature, the pressure added to the inside of the blow bottle was released, and a blow bottle having improved dimensions was obtained by annealing. An endless belt was obtained by cutting both ends of this blow bottle. This endless belt was used as an electrophotographic belt. The thickness of the electrophotographic belt was 70 μm. Table 6 shows the results of the evaluations (1) to (4) for this electrophotographic belt.

TABLE 6
<Examples 1 to 10>

| | | | | Example | | | | |
|---|---|---|---|---|---|---|---|---|
| | | No. | Unit | 1 | 2 | 3 | 4 | 5 |
| Composition | Polyester resin | 1 | [% by mass] | 99.4 | — | — | — | 91.0 |
| | | 2 | | — | — | — | 92.2 | — |
| | | 3 | | — | 98.6 | — | — | — |
| | Ionic compound | 1 | [% by mass] | 0.5 | — | — | — | — |
| | | 2 | | — | 1.0 | — | — | — |
| | | 3 | | — | — | 3.0 | — | — |
| | | 4 | | — | — | — | 6.0 | — |
| | | 5 | | — | — | — | — | 8.0 |
| | | 6 | | — | — | — | — | — |
| | Amide compound | 1 | [% by mas s] | 0.1 | — | 0.5 | 0.3 | 1.0 |
| | | 2 | | — | 0.4 | — | — | — |
| | PEEA | 1 | [% by mass] | — | — | — | — | — |
| | | 2 | | — | — | — | — | — |

| | Silicone particles | | [% by mass] | — | — | 0.5 | 1.5 | — |
|---|---|---|---|---|---|---|---|---|
| Amide compound/Ionic compound | | | [%] | 20.0 | 40.0 | 16.7 | 5.0 | 12.5 |
| Characteristic | Surface specific resistivity | | [logρs] | 9.90 | 9.80 | 9.40 | 8.80 | 8.40 |
| Evaluation | Toner | Initial | [%] | 94.1 | 93.7 | 94.1 | 94.4 | 93.8 |
| | transfer | After durability test | [%] | 93.2 | 92.7 | 93.1 | 94.2 | 92.8 |
| | efficiency | After leaving for 10 days | [%] | 92.6 | 92.3 | 92.9 | 93.8 | 92.5 |

| | | | | Example | | | | |
|---|---|---|---|---|---|---|---|---|
| | | No. | Unit | 6 | 7 | 8 | 9 | 10 |
| Composition | Polyester resin | 1 | [% by mass] | 84.3 | — | — | — | — |
| | | 2 | | — | 77.0 | 82.6 | 87.1 | 79.6 |
| | | 3 | | — | — | — | — | — |
| | Ionic compound | 1 | [% by mass] | — | — | — | — | — |
| | | 2 | | — | — | — | — | — |
| | | 3 | | — | — | — | — | — |
| | | 4 | | 0.5 | — | 1.0 | 2.0 | 3.0 |
| | | 5 | | — | — | — | — | — |
| | | 6 | | — | 2.0 | — | — | — |
| | Amide compound | 1 | [% by mas s] | — | 1.0 | 0.4 | — | 0.4 |
| | | 2 | | 0.2 | — | — | 0.4 | — |
| | PEEA | 1 | [% by mass] | 15.0 | — | 15.0 | — | 15.0 |
| | | 2 | | — | 20.0 | — | 10.0 | — |

| | Silicone particles | | [% by mass] | — | — | 1.0 | 0.5 | 2.0 |
|---|---|---|---|---|---|---|---|---|
| Amide compound/Ionic compound | | | [%] | 40.0 | 50.0 | 40.0 | 20.0 | 13.3 |
| Characteristic | Surface specific resistivity | | [logρs] | 9.15 | 8.60 | 9.05 | 9.10 | 8.65 |
| Evaluation | Toner | Initial | [%] | 94.4 | 94.0 | 95.0 | 94.6 | 94.3 |
| | transfer | After durability test | [%] | 94.0 | 93.0 | 94.7 | 94.2 | 94.2 |
| | efficiency | After leaving for 10 days | [%] | 93.5 | 92.5 | 94.6 | 94.0 | 94.1 |

### Examples 11 to 15

An endless belt was obtained in the same manner as in Example 1 except that the formulations shown in Table 7 were used. This endless belt was used as the base layer, and in order to improve the adhesion to other contact members, such as photosensitive drums and cleaning blades, and the releasability of toner, the outermost layer consisting of acrylic resin, which is an active energy ray-curable resin, was provided as follows.

The following materials were mixed as raw materials for the outermost layer of acrylic resin.

| | |
|---|---|
| dipentaerythritol hexaacrylate | 100 parts by mass |
| (Product name: Light acrylate DPE-6A, | |
| manufactured by Kyoeisha Chemical Co., | |
| Ltd.) | |
| carbon black (Ketchen black) | 15 parts by mass |
| (Product name: MHI Black # 273, | |
| manufactured by Mikuni Color Co., Ltd.) | |
| photopolymerization initiator | 5 parts by mass |
| (Product name: Irgacure (registered | |
| trademark) 184, manufactured by BASF | |
| Japan Ltd.) | |

This mixture was diluted with methyl ethyl ketone so that the resin solid content became 6% by mass, and stirred with a stirrer to provide a uniform mixed solution for forming the outermost layer of acrylic resin. This mixed solution was uniformly applied to the outer peripheral surface of the above base layer by a spray method, dried at 60° C. for one minute to remove the solvent, and then irradiated with ultraviolet rays to be cured. This provided an electrophotographic belt having an outermost layer of acrylic resin having a thickness of 2 μm formed on the outer peripheral surface of the base layer. Using an ultraviolet irradiator (product name: UE06/81-3, manufactured by Eye Graphics Co., Ltd.) as an ultraviolet source to irradiate with ultraviolet rays until the integrated light amount reached 1000 mJ/cm², the UV curing of the outermost layer of acrylic resin was performed. Table 7 shows the results of the evaluations of (1) to (4) for the obtained electrophotographic belt.

TABLE 7
<Examples 11 to 15>

| | | | | Example | | | | |
|---|---|---|---|---|---|---|---|---|
| | | No. | Unit | 11 | 12 | 13 | 14 | 15 |
| Composition | Polyester resin | 1 | [% by mass] | 98.6 | — | — | 80.5 | — |
| | | 2 | | — | 82.5 | 85.0 | — | 85.1 |
| | Ionic compound | 2 | [% by mass] | 1.0 | — | — | — | — |
| | | 3 | | — | 2.0 | — | — | 4.0 |
| | | 4 | | — | — | 3.0 | 2.0 | — |
| | Amide compound | 1 | [% by mass] | 0.4 | — | 1.0 | 1.0 | — |
| | | 2 | | — | 0.5 | — | — | 0.4 |
| | PEEA | 1 | [% by mass] | — | 15.0 | 10.0 | 15.0 | 10.0 |

| | Silicone particles | | [% by mass] | — | — | 1.0 | 1.5 | 0.5 |
|---|---|---|---|---|---|---|---|---|
| Amide compound/Ionic compound | | | [%] | 40.0 | 25.0 | 33.3 | 50.0 | 10.0 |
| Characteristic | Surface specific resistivity | | [logρs] | 10.10 | 9.15 | 9.20 | 9.15 | 9.00 |
| Evaluation | Toner | Initial | [%] | 98.8 | 99.0 | 99.3 | 99.1 | 99.3 |
| | transfer | After durability test | [%] | 98.0 | 98.5 | 98.8 | 98.4 | 98.6 |
| | efficiency | After leaving for 10 days | [%] | 97.8 | 98.5 | 98.7 | 98.4 | 98.5 |

As shown in Table 6 and Table 7, in the toner transfer efficiency evaluation of the electrophotographic belt, the toner transfer efficiency after leaving for 10 days after the durability test was 92% in all of the material compositions of Examples 1 to 15, indicating good results.

### Comparative Examples 1 to 7

An electrophotographic belt was produced in the same manner as in Example 1 or Example 11 except that the material types and blending amounts were as shown in Table 8 below. These evaluation results are shown in Table 8.

TABLE 8
<Comparative Examples 1 to 7>

| | | | | Comparative Example | | | | | | |
|---|---|---|---|---|---|---|---|---|---|---|
| | | No. | Unit | 1 | 2 | 3 | 4 | 5 | 6 | 7 |
| Composition | Polyester resin | 2 | [% by mass] | 97.0 | 93.0 | 83.0 | 97.0 | 93.5 | 83.0 | 81.5 |
| | Ionic compound | 2 | [% by mass] | — | — | — | — | — | 6.0 | — |
| | | 4 | | — | — | — | 3.0 | 6.0 | — | 3.0 |
| | | 7 | | 3.0 | 6.0 | 6.0 | — | — | — | — |
| | Amide compound | 2 | [% by mass] | — | 1.0 | 1.0 | — | — | — | — |
| | | 3 | | — | — | — | — | 0.5 | 1.0 | 0.5 |
| | PEEA | 1 | [% by mass] | — | — | 10.0 | — | — | 10.0 | 15.0 |

| Amide compound/Ionic compound | | | [%] | — | 16.7 | 16.7 | — | 8.3 | 16.7 | 16.7 |
|---|---|---|---|---|---|---|---|---|---|---|
| Characteristic | Surface specific resistivity | | [logρs] | 9.34 | 8.68 | 8.18 | 9.34 | 8.68 | 8.18 | 8.59 |
| Evaluation | Toner | Initial | [%] | 93.1 | 94.5 | 93.8 | 94.1 | 94.4 | 94.6 | 98.6 |
| | transfer | After durability test | [%] | 89.5 | 90.8 | 88.4 | 91.2 | 89.6 | 90.8 | 92.3 |
| | efficiency | After leaving for 10 days | [%] | 75.6 | 71.1 | 74.9 | 76.3 | 73.8 | 74.4 | 76.2 |

In Comparative Examples 1, 2, and 3, a cation containing no hydroxyl group (ionic compound 7) was contained. In Comparative Examples 1 and 4, no amide compound was contained. In Comparative Examples 5, 6, and 7, a compound having one amide group was contained instead of the compound having at least two amide groups in one molecule. In addition, in Comparative Example 7, the outermost layer consisting of acrylic resin was provided.

In any of the comparative examples, the toner transfer efficiency after leaving for 10 days after the durability test was 10% or more lower than the initial toner transfer efficiency and that after durability test. This result verifies that the affinity due to the interaction between the thermoplastic polyester resin and the cation is not improved except for the combination of the cation specified in the present disclosure and the compound having an amide group, and no effect of suppressing the adhesion of bleeds on the belt surface is obtained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-076692, filed Apr. 23, 2020, and Japanese Patent Application No. 2021-020725, filed Feb. 12, 2021, which are hereby incorporated by reference herein in their entirety.

What is claimed is:

1. An electrophotographic belt comprising:
a first layer, the first layer comprising a thermoplastic resin composition,
the thermoplastic resin composition comprising:
a thermoplastic polyester resin;
a cation having a hydroxyl group;
an anion; and
an amide compound having at least two amide groups in one molecule.

2. The electrophotographic belt according to claim 1, wherein the amide compound has a molecular weight of 1000 or less.

3. The electrophotographic belt according to claim 1, wherein the cation has two or more hydroxyl groups in one molecule.

4. The electrophotographic belt according to claim 1, wherein the cation is at least one cation selected from the group consisting of an ammonium-based ion, an imidazolium-based ion, a pyridinium-based ion, a piperidinium-based ion, a pyrrolidinium-based ion, and a phosphonium-based ion.

5. The electrophotographic belt according to claim 1, wherein the anion has a structure represented by a following formula (1): 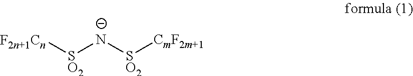
wherein m and n each independently represent an integer of 1 or more and 4 or less.

6. The electrophotographic belt according to claim 1, wherein the thermoplastic polyester resin comprises at least one selected from polyalkylene terephthalate and polyalkylene naphthalate.

7. The electrophotographic belt according to claim 6, wherein the polyalkylene terephthalate is polyethylene terephthalate.

8. The electrophotographic belt according to claim 6, wherein the polyalkylene naphthalate is polyethylene naphthalate.

9. The electrophotographic belt according to claim 1, wherein the amide compound is a fatty acid bisamide and/or an aromatic bisamide.

10. The electrophotographic belt according to claim 9, wherein the fatty acid bisamide is an ethylene bis(fatty acid amide).

11. The electrophotographic belt according to claim 1, wherein an amount of an ionic compound having the cation and the anion is 0.5% by mass or more and 8% by mass or less with respect to a total amount of a thermoplastic resin composition.

12. The electrophotographic belt according to claim 1, wherein a mass of a compound having at least two amide groups in one molecule is 2% or more and 80% or less with respect to a mass of an ionic compound having the cation and the anion.

13. The electrophotographic belt according to claim 1, wherein the thermoplastic resin composition further comprises a polyether ester amide.

14. The electrophotographic belt according to claim 1, further comprising a second layer comprising a cured product of a composition comprising an active energy ray-curable resin.

15. The electrophotographic belt according to claim 1, wherein the electrophotographic belt has an endless belt shape.

16. The electrophotographic belt according to claim 1, having an endless shape and further comprising a second layer covering an outer peripheral surface of the first layer,
wherein the second layer comprises a cured product of a composition comprising an active energy ray-curable resin.

17. An electrophotographic image forming apparatus comprising an intermediate transfer belt,
wherein the intermediate transfer belt is an electrophotographic belt comprising a first layer, the first layer comprising a thermoplastic resin composition comprising:
a thermoplastic polyester resin;
a cation having a hydroxyl group;
an anion; and
an amide compound having at least two amide groups in one molecule.

18. A method of producing an electrophotographic belt having an endless belt shape, and is provided with a first layer comprising a thermoplastic resin composition, the method comprising steps of:
(i) thermally melt-kneading a thermoplastic polyester resin, an ionic compound containing a cation having a hydroxyl group and an anion, and an amide compound having at least two amide groups in one molecular to form the thermoplastic resin composition; and
(ii) molding the thermoplastic resin composition into an endless belt shape.

19. The method according to claim 18, including melt-extruding the thermoplastic polyester resin, the ionic compound and the amide compound into a cylindrical shape.

20. The method according to claim 18, including a step of molding the thermoplastic resin composition into an endless belt shape by injection molding, stretch blow molding or inflation molding.
